(19) United States
(12) Patent Application Publication
(10) Pub. No.: US 2011/0086178 A1
(43) Pub. Date: Apr. 14, 2011

(54) CERAMIC COATINGS AND METHODS OF MAKING THE SAME

(75) Inventors: James Anthony Ruud, Delmar, NY (US); Leonardo Ajdelsztajn, Niskayuna, NY (US)

(73) Assignee: GENERAL ELECTRIC COMPANY, SCHENECTADY, NY (US)

(21) Appl. No.: 12/578,991

(22) Filed: Oct. 14, 2009

(51) Int. Cl. B05D 1/08

(52) U.S. Cl. 427/447; 427/446

(57) ABSTRACT

A method for forming a ceramic coating is provided. The method includes providing a slurry comprising a liquid and a plurality of feedstock particles disposed in the liquid, injecting the slurry into the flame of a thermal spray gun, and spraying the slurry on a surface of a substrate using the thermal spray gun to form the ceramic coating such that at least a part of the surface of the substrate is covered by the ceramic coating, wherein a thickness of the ceramic coating is in a range from about 10 nanometers to about 3 micrometers, and wherein a density of the ceramic coating is more than about 90 percent, and wherein the ceramic coating is a continuous coating.

### BACKGROUND

The invention relates generally to ceramic coatings and methods of making the same, and particularly to electrically conductive ceramic coatings and methods of making the same.

Typically, vacuum based deposition techniques are employed for forming electrically conductive coatings or thin layers of ceramic material. For example, in electrical devices in the field of photovoltaics, a thin layer of transparent material, such as indium tin oxide, is often deposited. It is desirable to deposit as thin a layer as possible to enable better optical transparency and current flow through the layer. Some of the methods currently employed to deposit such coatings include chemical vapor deposition (CVD), physical vapor deposition (PVD), laser assisted pyrolysis deposition, and electron-beam physical vapor deposition.

One of the current methods to deposit such coatings, CVD, is a materials synthesis process in which constituents of the vapor phase react chemically either near or on a substrate surface to form a solid product. In most cases, gas phases flow into a reaction chamber where CVD occurs. The reaction occurs at an elevated temperature to heat the material substrate that is to be coated. The elevated temperature may be provided by a furnace, a high-intensity radiation lamp, or by a method, such as RF induction. Due to these requirements and others, CVD processes require very specific operating conditions, apparatuses and reactants and carriers. The use of a reaction chamber limits such techniques to operate in a batch mode and can limit the size of the deposition areas. The capital and operating expenses can also be significant for such techniques.

In contrast to the above referenced methods, thermal spray is relatively more flexible with regard to deposition parameters and feedstock. Thermal spray may employ a solid, a powdered feedstock, a dispersion of a solid, powdered feedstock in a liquid carrier, or a liquid precursor. Thermal spray is highly flexible with regard to the composition of the feedstock owing to the variety of available flame types, velocities and flame temperatures and resulting in a wide compositional variety in the produced materials. Additionally, thermal spray generally is highly efficient making it a cost effective method. However, conventional thermal spray processes have heretofore had a limitation with respect to thickness of the coatings. Because of the size of the particle feedstock used in conventional thermal spray, typically coatings have a thickness in a range of about 75 microns to about 1000 microns. Such high thickness values are not suitable for applications such as photovoltaics.

Therefore, there is a need for a cost effective method of material deposition that can produce materials and coatings with a variety of compositions while retaining the desirable microstructure and physical properties of the coating materials.

### BRIEF DESCRIPTION

In one embodiment, a method for forming a ceramic coating is provided. The method includes providing a slurry comprising a liquid and a plurality of feedstock particles disposed in the liquid, injecting the slurry into the flame of a thermal spray gun, and spraying the slurry on a surface of a substrate using the thermal spray gun to form the ceramic coating such that at least a part of the surface of the substrate is covered by the ceramic coating, wherein a thickness of the ceramic coating is in a range from about 10 nanometers to about 3 micrometers, and wherein a density of the ceramic coating is more than about 90 percent, and wherein the ceramic coating is a continuous coating.

In another embodiment, a method for forming a ceramic coating is provided. The method includes providing a slurry comprising a liquid and a feedstock, wherein the feedstock comprises indium tin oxide (ITO) particles, wherein a size of the ITO particles has a d90 less than about 3 microns, feeding the slurry in a thermal spray gun device, and spraying the slurry on a surface of a substrate to form the optically transparent ceramic coating.

### DRAWINGS

These and other features, aspects, and advantages of the present invention will become better understood when the following detailed description is read with reference to the accompanying drawings in which like characters represent like parts throughout the drawings, wherein:

FIG. 1 is a flow chart illustrating an example of various steps involved in the fabrication of the ceramic coating of the invention;

FIG. 2 is a micrograph of an example of a ceramic coating formed by employing the method of the invention; and

FIG. 3 is a graphical representation of transparency data for different ceramic coatings formed by employing the method of the invention.

### DETAILED DESCRIPTION

The present invention provides a method for deposition of transparent coatings based on thermal spray methods. The ceramic coatings deposited by employing the methods of the present invention are transparent to ultraviolet, visible, or infrared radiation, meaning they allow at least about 30 percent of the incident radiation of at least one wavelength in the spectrum range from infrared through ultraviolet (that is, any wavelength of infrared, visible, or ultraviolet radiation) to transmit through the material. In some embodiments this fraction of transmitted radiation is significantly higher, such as greater than about 50 percent, and even greater than 70 percent in particular embodiments. In some embodiments, the ceramic coatings are “optically transparent”. As used herein, the term “optically transparent” means able to transmit about 70 percent of the incident visible light.

The coatings may also be electrically conductive. As used herein, the term “electrically conductive” means able to conduct an electrical current with an electrical sheet resistance of less than about 1000 ohms/cm². The coatings formed by employing the methods of the present invention may be very thin with a thickness in a range from about 10 nanometers to about 3 micrometers. In certain embodiments, the density of the ceramic coating is more than about 90 percent of theoretical density. In one embodiment, the ceramic coating is a continuous coating. As used herein, the term “continuous coating” refers to coating that has a contiguous path for electron transport that is substantially free of any accidental type defect such as a pore or crack. The term “continuous coating” encompasses any coating patterns formed by such coatings, where any gaps in the coating are not accidental but predetermined.

Conventionally, in thermal spray processing, a coating material or feedstock is fed in the powder or wire form, heated to a molten or semi-molten state and accelerated towards a substrate in the form of usually micrometers size particles. Combustion or electrical arc discharge is usually used as the source of energy for thermal spraying. Resulting coatings are made by the accumulation of numerous sprayed particles. Typically many defects are present in the coatings from the sprayed particle boundaries, entrained porosity and interlamellar cracking. Typically, depending on the feedstock and process, the coatings formed by thermal spraying are tens of micrometers to several millimeters thick. Therefore, it is extremely difficult to achieve optically transparent thin coatings using thermal spray based techniques. Surprisingly it has been found that by using sub-micron, slurry-fed particles in the thermal spray process, and by controlling the various parameters of the thermal spraying process, such as the feedstock particle size, feedstock particle distribution, and slurry medium, it is possible to obtain dense, continuous coatings that have good surface finish and sub-micron thickness, and are optically transparent, electrically conductive, and/or infra-red (IR) reflective. Advantageously, the thermal spray coatings can be deposited over large areas and at high deposition rates as compared to other coating processes, such as electro-deposition, physical vapor deposition (PVD), or chemical vapor deposition (CVD).

Conventional plasma spraying enables deposition of coatings having thickness from several micrometers to several millimeters. The material to be deposited, that is, the feedstock, is introduced into the plasma jet emanating from a plasma torch. There are a large number of technological parameters that influence the interaction of the particles with the plasma jet and the substrate and therefore the deposit properties. Some of these parameters include feedstock chemical composition, feedstock particle size, plasma gas composition and flow rate, energy input, torch offset distance, and substrate temperature.

Typically, in thermal spray process, the deposits consist of a plurality of lamellae called ‘splats’, formed by flattening of the liquid droplets. As the feedstock powders typically have sizes from micrometers to above 100 micrometers, the lamellae have thickness in the micrometer range and lateral dimension from several to hundreds of micrometers. Between these lamellae, there are often small voids, such as pores, cracks and regions of incomplete bonding. As a result of this unique structure, the deposits can have properties significantly different from bulk materials.

It has been unexpectedly discovered that manipulating the feedstock particle size in sub-micron to nanometer range, and suspending the feedstock particles in a liquid to form a slurry that is fed to the plasma torch, enables deposition of continuous thin films that retain characteristics of the thermally sprayed particles. In one example, feedstock particles include indium tin oxide (ITO) particles to deposit thermally sprayed thin films that are optically transparent and electrically conductive. Although conventional high velocity oxygen fuel (HVOF) coatings are typically as thick as 12 millimeters, using the present invention, thin continuous coatings of less than about 3 micrometers thickness can be deposited while employing HVOF.

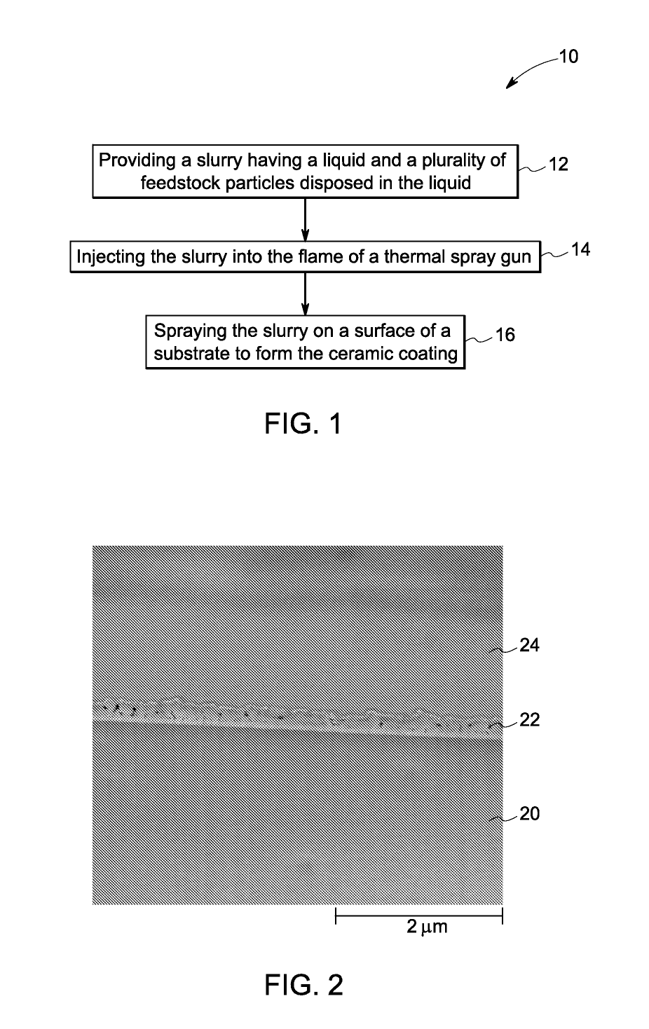

Referring now to FIG. 1, the flow chart 10 illustrates a method for forming a ceramic coating using thermal spray techniques. The ceramic coating may include an oxide coating, a silicide coating, or a nitride coating. At block 12, a slurry having a liquid and a plurality of feedstock particles disposed in the liquid is provided. The slurry includes a liquid and a plurality of feedstock particles disposed in the liquid. As used herein, the term “feedstock” refers to material of the desired coating. The term “feedstock particles” refers to particles of the desired coating. For example, for a coating that is transparent to ultraviolet, visible, or infrared radiation, the feedstock would comprise particles of oxides, silicides or nitrides that have the desired transparency to the radiation. For example, for an optically transparent indium tin oxide coating, the feedstock particles may include particles of ITO. Other non-limiting examples of transparent particles include silica, tin oxide, doped tin oxide, zinc oxide, aluminum oxide, yttrium aluminum oxide, doped yttrium aluminum oxide, aluminum oxynitride, magnesium aluminate, yttrium oxide, and the rare earth oxides. For a coating that is electrically conductive, the feedstock would comprise particles of oxides, silicides or nitrides that have the desired electrical conductivity. For example, for an electrically conductive manganese cobalt oxide coating, the feedstock particles may include manganese cobalt oxide (Mn_{1.5}Co_{1.5}O₄). Other non-limiting examples of electrically conductive particles include chromium oxide, doped chromium oxide, perovskite oxides, spinel oxides, tin oxide, doped tin oxide, and zinc oxide. Non-limiting examples of suitable liquids may include one or more of water, alcohol, and organic combustible or non-combustible liquids. For example, the liquids may include one or more of water, ethanol, methanol, hexane, and ethylene glycol. The feedstock particles may be soluble or non-soluble (suspended) in the liquid.

The concentration or loading of the slurry is in a range from about 0.1 weight percent to about 50 weight percent. In particular embodiments, the concentration of the slurry is in a range from about 0.5 weight percent to about 25 weight percent.

In certain embodiments, the d90 of the particle size distribution of the plurality of feedstock particles is less than about 3 microns; in some embodiments, this d90 is less than about 1 micron, and in particular embodiments is less than about 0.5 microns. As used herein, the term “d90” is the 90^{th} percentile particle diameter for the feedstock particle population. In other words, 90 percent of the particles of the particle size distribution have a diameter smaller than the values given for the respective embodiments.

In accordance with embodiments described herein, a laser diffraction technique is employed to determine the particle size distribution of the solid particles in a liquid suspension. A sample of the suspension is placed in the measurement volume of a laser scattering particle size distribution analyzer and the laser light scattering characteristics are evaluated using Mie scattering theory to determine a particle size distribution. In some embodiments, the particles are subjected to ultrasonic agitation prior to measuring the particle size distribution. As will be appreciated, particles can agglomerate in suspension to give a particle size measurement that is greater than the representative values. The use of ultrasonic agitation facilitates breaking of the agglomerates to characterize the particle size more accurately. It was observed in particular that the d90 value was best characterized after sufficient ultrasonic agitation and produced a stable measurement. Thus, as used herein, unless explicitly stated otherwise, a reference to particle size or particle size distribution will mean size as determined by laser diffraction as described above after at least 30 seconds and up to 10 minutes of ultrasonic agitation of the sample at 40 Watts and 39 KHz.

At block 14, the slurry is injected into the flame of a thermal spray gun. The coating material is passed to the gun and fed into the flame to melt or heat the feedstock, and the slurry is then propelled within the flame to be sprayed on a surface of a substrate.

The thermal spray gun may be a plasma torch, or a combustion flame spray device, or a HVOF gun, or a high velocity air fuel (HVAF) gun. HVOF enables deposition of coatings with less porosity and good bond strength. The slurry may be internally injected in the thermal spray gun device. In one embodiment, the plasma torch may be fed with the slurry either axially or radially. In embodiments where HVOF or HVAF guns are employed, the slurry is usually fed axially. However, in some embodiments, HVOF guns may be radially fed.

At block 16, the slurry is sprayed on a surface of a substrate using the thermal spray gun to form the ceramic coating such that at least a part of the surface of the substrate is covered by the ceramic coating. The substrate material must be capable of withstanding the conditions of the thermal spray processes without structural degradation.

Suitable examples of the substrate may include plastic, glass, glass ceramic, metal, metal alloy, ceramic, cermets, semiconductor, or combinations thereof. In one embodiment, the substrate may include quartz.

In one embodiment, the substrate may be pre-heated. In one embodiment, the surface may be cleaned to improve adhesion between the substrate surface and the coating. For example, the substrate may be cleaned to remove any impurities such as undesirable oxide formation, presence of grease.

The ceramic coatings of the present invention may be employed for any applications that require optically transparent, or electrically conductive films. In one embodiment, the indium tin oxide ceramic coatings may be employed in photovoltaic applications as optically transparent and electrically conductive thin film coatings.

### Example

HVOF and Plasma spray were used to produce different ceramic coatings. The HVOF gun used in this experiment was a DJ3600 gun (Sulzer Metco). The plasma gun was a Mettech axial feed gun. In each of the coatings, slurry was prepared by milling ITO powder in ethanol and yttria stabilized zirconia (YSZ) milling media for different times varying from about 18 hours to about 140 hours. The slurries were diluted by ethanol to a 10 weight percent concentration before the thermal spray runs. The d90 of the slurries that were subjected to milling for 112.5 hours before taking the particle size distribution measurement was about 0.33 microns. The slurry was fed in the HVOF or plasma spray gun by a pressurized container. The pressure of the container was changed according to the need for each gun. For example, in the case of the HVOF, there is a need to overcome the combustion pressure in order to feed the slurries into the nozzle. It was found in this instance that 90 psi was an appropriate pressure. The plasma gun required lower pressures, on the order of 20 psi to 50 psi, as there was no combustion pressure to overcome during feeding. The coatings were produced by axially feeding the slurries into the thermal spray guns. Unless otherwise specified, quartz slides were employed as the substrate. The gun was mounted on a 6 axis robotic arm and traversed across the substrate in a series of stepped passes to coat the sample surface. The coatings were produced by placing the substrate from 3 inches to 7 inches from the HVOF gun, and 2 inches to 5 inches from the plasma gun.

FIG. 2 is a micrograph for an ITO coating 20 deposited on a quartz substrate 22 by employing the method of the present invention. Reference numeral 24 represents platinum film deposited on the ITO coating. The platinum film 24 was deposited using electron beam sputtering.

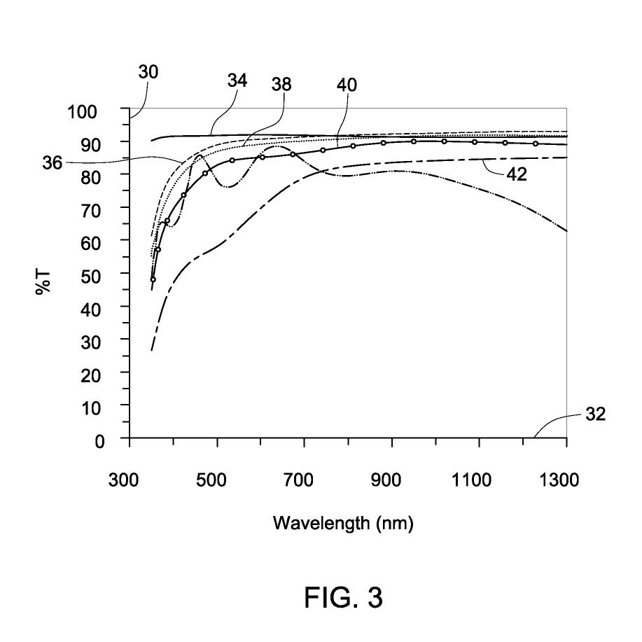

FIG. 3 represents optical transparency values of the various coatings deposited by employing the method of the present invention. Ordinate 30 represents the optical transparency with respect to wavelength (abscissa 32) of the light. Curve 34 represents the transparency for a glass substrate. Curves 36, 38 and 40 represent transparency values for plasma spray deposited coatings that were produced from a suspension of particles with a d90 of about 330 nanometers. The transparency values represented by the curves 36, 38 and 40 include the transparency values of the substrate underneath. The distance between the substrate and the gun was 4.5 inches, 4 inches, and 3.5 inches for the coatings represented by the curves 36, 38 and 40, respectively. Curve 42 represents transparency values for a HVOF deposited coating produced from a suspension of particles with a d90 of about 1.4 microns. The transparency value for the substrate was subtracted from the transparency value for the HVOF deposited coating.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for forming a ceramic coating comprising:
providing a slurry comprising a liquid and a plurality of feedstock particles disposed in the liquid;
injecting the slurry into the flame of a thermal spray gun; and
spraying the slurry on a surface of a substrate using the thermal spray gun to form the ceramic coating such that at least a part of the surface of the substrate is covered by the ceramic coating, wherein a thickness of the ceramic coating is in a range from about 10 nanometers to about 3 micrometers, and wherein a density of the ceramic coating is more than about 90 percent, and wherein the ceramic coating is a continuous coating.

2. The method of claim 1, wherein the liquid comprises water, alcohol, an organic combustable liquid, an organic non-combustible liquid, or combinations thereof.

3. The method of claim 1, wherein the liquid comprises water, ethanol, methanol, hexane, ethylene glycol, or combinations thereof.

4. The method of claim 1, wherein the thermal spray gun device comprises a plasma torch, or a combustion flame spray device, or a HVOF device, or a HVAF device, or combinations thereof.

5. The method of claim 1, further comprising internally injecting the slurry in the thermal spray gun device.

6. The method of claim 1, wherein a d90 of the plurality of feedstock particles is less than about 3 microns.

7. The method of claim 1, wherein a d90 of the plurality of feedstock particles is less than about 1 micron.

8. The method of claim 1, wherein a d90 of the plurality of feedstock particles is less than about 0.5 microns.

9. The method of claim 1, wherein the particles are present in the slurry at a concentration in the range from about 0.1 weight percent to about 50 weight percent.

10. The method of claim 9, wherein the particles are present in the slurry at the concentration in the range from about 0.5 weight percent to about 25 weight percent.

11. The method of claim 1, wherein the ceramic coating comprises an oxide, a silicide, or a nitride.

12. The method of claim 1, wherein the substrate is made of a plastic, a glass, a glass ceramic, a metal, a metal alloy, a ceramic, a cermet, a semiconductor, or combinations thereof.

13. The method of claim 12, wherein the substrate comprises quartz.

14. A method for forming a ceramic coating comprising:
providing a slurry comprising a liquid and a feedstock, wherein the feedstock comprises indium tin oxide (ITO) particles, wherein the size of the ITO particles has a d90 less than about 3 microns;
feeding the slurry in a thermal spray gun device; and
spraying the slurry on a surface of a substrate to form the optically transparent ceramic coating.
